(19) United States
(12) Patent Application Publication
(10) Pub. No.: US 2005/0262328 A1
(43) Pub. Date: Nov. 24, 2005

(54) Processor and method for processing vliw instructions

(76) Inventor: Karolien Madeleine Michel De Baere, LEUVEN (BE)

Correspondence Address: PHILIPS INTELLECTUAL PROPERTY & STANDARDS, P.O. BOX 3001, BRIARCLIFF MANOR, NY, 10510, US

(21) Appl. No.: 10/523,383

(22) PCT Filed: Jul. 16, 2003
(86) PCT No.: PCT/IB03/03017

§ 371 Date: Feb. 1, 2005

(30) Foreign Application Priority Data
Aug. 5, 2002 (EP) 02078215.7

(51) Int. Cl. G06F 15/00

(52) U.S. Cl. 712/205; 712/24

(57) ABSTRACT

Described are a processor device and a method for processing instructions, in particular VLIW instructions, wherein instruction words are stored in a memory means, each instruction word consisting of segments, the instruction words are fetched from the memory means, and instructions are executed in accordance with instruction words fetched from the fetching means. The particularity of the invention is in that essentially those segments of an instruction word are fetched only which contain relevant information.

### FIELD OF THE INVENTION

The present invention relates to a processor device for processing instructions, in particular very long instruction word (VLIW) instructions, comprising memory means for storing instructions words, each instruction word consisting of segments, fetching means for fetching instruction words from said memory means, and executing means for executing instructions in accordance with instruction words fetched from said fetching means. Further, the present invention relates to a method for processing instructions, in particular very long instruction word (VLIW) instructions, in a processor device, comprising the steps of storing instruction words in a memory means, each instruction word consisting of segments, fetching instruction words from said memory means, and executing instructions in accordance with instruction words fetched from said fetching means.

### TECHNICAL BACKGROUND

Most present processors offer instruction level parallelism. This parallelism is most of the time not fully exploited since not each computational unit of the processor is active at every cycle. For VLIW (Very Long Instruction Width) processor, this lack of operation is presented by a NOP (no operation) segment in the instruction word. There are two kinds of VLIW processors, namely a basic VLIW processor and a variable length VLIW processor.

Basic VLIW processors always fetch the entire instruction word, including the NOP segments which represent no operations. If the instruction word is stored over multiple lines of the program memory, fetching all the lines of the instruction requires many memory accesses, thus reinforcing the memory bottleneck, which is often not necessary. However, the fetching of an entire instruction word, irrespective of whether it is stored on one program line or on several program lines, is power consuming and time wasting.

Variable length VLIW processors are smarter. Their instruction word is compressed and contains only relevant information. The fact that only this information is fetched from the program memory is beneficial both to increase the performance and to reduce the power consumption. Furthermore, this technique offers the advantage that the code size density is improved, resulting in the provision of a smaller program memory. However, since each instruction word is compressed in a different way, the length of the instructions varies, and an instruction is stored on multiple program lines in the memory. To each instruction word, a field is added indicating how the instruction needs to be fetched and how it needs to be decompressed. Depending on the processor, this overhead applies to the current or one of the subsequent instructions. The processor hardware must be capable of fetching and decompressing each instruction depending on the additional information. So, the execution of conditional jump and branch routines complicates severely the fetching and decoding of the instruction word and, thus, the whole processing operation of the instruction words.

U.S. Pat. No. 5,774,737 A discloses a variable word length VLIW-instruction processor, wherein a VLIW-instruction word length register is provided. A VLIW-instruction contains an indication as to VLIW-instruction word length such as a VLIW-instruction word length rewrite instruction. Based on this instruction, the VLIW-instruction word length of the VLIW-instruction word length register is rewritten. For the case of normal instructions (object programs) without any indication of the VLIW-instruction word length, a VLIW-instruction word length that is stored in the VLIW-instruction word length register is initialized to a predetermined value by, for example, the loading of an initial program performed at the time of power-on. This initialized instruction word length is used as a fixed value, and an object program for a conventional processor is executed. Accordingly, even when the number of instructions that are simultaneously executed is set low, “NOP (non-execution)” is lessened and the effective use of the instruction memory becomes possible.

From U.S. Pat. No. 5,848,288 A it is known a method and apparatus which permits a computer system to execute variable size instruction bundles. A processor fetches an instruction issue group of the size it can issue in one cycle. By detecting if an end of bundle exists in an instruction issue group and disabling the issue of instruction following an end of bundle, the computer is enabled to execute code compiled for arbitrary bundle size.

According to the teaching of EP 0 881 575 A1, in a cache memory of a super-scalar or VLIW processor to concurrently process a plurality of memory accesses, to provide a memory capable of multi-port access operation, there is provided a unit which subdivides the cache memory into a plurality of memory banks for concurrent operations thereof and which allocates memory ports independently to the respective memory banks. In a first cycle, the first and second memory ports are allocated to the first and second memory banks, respectively. If a hit occurs, the plural accesses are completed in one cycle. If a miss results, the first and second memory ports are allocated respectively to the second and first memory banks in a second cycle.

U.S. Pat. No. 6,249,861 B1 discloses an instruction fetch unit aligner for a non-power of two size VLIW instruction, which includes a selection logic for selecting the non-power of two size instruction from power of two size instruction data and a control logic for controlling the selection logic.

U.S. Pat. No. 5,878,267 A describes a compressed instruction format for use in a VLIW processor and a processor for processor such instructions, wherein software creates a compressed instruction format for a VLIW processor which allows greater efficiency in use of cache and memory. Instructions are byte aligned and variable length. Branch targets are uncompressed. Format bits specify how many issue slots are used in a following instruction. NOP segments are not stored in the memory. Individual operations are compressed according to features such as whether they are resultless, guarded, short, zeroary, unary, or binary. Instructions are stored in compressed form in the memory and in the cache. Instructions are decompressed on the fly after being read out from the cache.

According to U.S. Pat. No. 6,085,306 A, for a processor executing highly efficient VLIW instructions, a 32-bit instruction is composed of a 4-bit format field, a 4-bit operation field, and two 12-bit operation fields. The 4-bit operation field can only include an operation code “cc” that indicates a branch operation which uses a stored value of the implicitly indicated constant register as the branch address, or a constant “const”. The content of the 4-bit operation field is specified by a format code provided in the format field.

### SUMMARY OF THE INVENTION

It is an object of the present invention to overcome the above mentioned drawbacks of the prior art and to increase the performance for processing instructions and to decrease the power consumption needed for such processing.

In order to achieve the above and further objects, in accordance with a first aspect of the present invention, there is provided a processor device for processing instructions, in particular VLIW instructions, comprising memory means for storing instruction words, each instruction word consisting of segments, fetching means for fetching instruction words from said memory means, and executing means for executing instructions in accordance with instruction words fetched from said fetching means, characterized in that said fetching means is adapted to fetch essentially those segments of an instruction word only which contain relevant information.

In accordance with a second aspect of the present invention, there is provided a method for processing instructions, in particular VLIW instructions, in a processor device, comprising the steps of storing instruction words in a memory means, each instruction word consisting of segments, fetching instruction words from said memory means, and executing instructions in accordance with instruction words fetched from said fetching means, characterized in that essentially those segments of an instruction word are fetched only which contain relevant information.

The basic principle of the technique proposed by the present invention is to fetch only the segments of the instruction words which contain relevant information although the entire instruction words are available in the memory means.

So, in accordance with the teaching of the present invention, the loading of such segment of the instruction word is skipped which segment is not used for the current instruction and, thus, contains a NOP. Since no redundant instruction segments are fetched, the advantages of increased performance and reduced power consumption are attained as in the variable length VLIW processor. Further, the technique of the present invention requires no complicated operations when fetching and decoding the instruction words, so that the fetching and decoding of the instruction words can be simply carried out, in particular since conditional jump and branch instructions can easily be handled. Usually, in the instruction word an instruction header is provided which is used to indicate whether or not loading of an instruction segment is required, i.e. whether or not such a segment contains a NOP.

Thus, the technique of the present invention combines the advantages of a compressed instruction word resulting to higher performance and power consumption without the drawback of complicated instruction fetch and decompression operations.

Further advantageous embodiments of the present invention are defined in the dependent claims.

Preferably, the instruction words have the same code size density and are not compressed. So, the code size density remains the same as in a basic VLIW processor. As a positive consequence, no additional mechanism is needed to fetch and decompress variable length compressed instructions as it is required with a variable length VLIW processor.

Usually, the memory means comprises a plurality of memory portions wherein each memory portion is provided to store one segment of an instruction word, and the fetching means is adapted to access those memory portions only which contain relevant information.

Preferably, the memory means includes a plurality of lines, each line being provided for storing a complete instruction word.

In a preferred embodiment of the present invention, the width of the memory means is divided over all lines into memory units in accordance with different segments of the instruction words so that each memory unit is formed by memory portions for storing instruction word segments of the same order and/or kind. So, the memory means is divided according to the different instruction word segments.

In accordance with a further preferred embodiment of the present invention, all segments of the instruction words and the memory means have the same width, and each memory portion forms a separate line for storing an instruction segment. So, each instruction word segment is stored on one line of the memory means.

In a still further preferred embodiment of the present invention, each line of the memory means is divided into said memory portions in accordance with different segments of the instruction words so that each memory portion is provided for storing one segment of an instruction word. So, the entire instruction word is stored on one line of the memory means, but only partially selected by the fetching means when fetched.

The above described objects and other aspects of the present invention will be better understood by the following description and the accompanying figures.

### BRIEF DESCRIPTION OF THE DRAWINGS

Preferred embodiments of the present invention are described with reference to the drawings in which

FIG. 1 shows a diagram of the implementation of the fetching technique of the present invention in accordance with a first embodiment;

FIG. 2 shows a diagram of the implementation of the fetching technique of the present invention in accordance with a second embodiment; and

FIG. 3 shows a diagram of the implementation of the fetching technique of the present invention in accordance with a third embodiment.

### DETAILED DESCRIPTION OF PREFERRED EMBODIMENTS

In the following, the fetching of instruction words for VLIW (very long instruction word) processors is described. Such instruction words are stored in a program memory which is included in the processor. Further, the processor includes an executing unit for executing certain operations in accordance with the instruction words.

The basic principle of the proposed technique is to fetch only the segments of the instruction words that contain relevant information, although the entire instruction word is available in the program memory of the processor. The instruction word is not compressed. Thus, the code size density remains the same as in a basic VLIW processor. As a positive consequence, no additional mechanism is required to fetch and decompress variable length compressed instructions. Since no redundant instruction segments are fetched, the advantages of increased performance and reduced power consumption are attained as in the variable length VLIW processor.

Conditional jump and branch instruction can easily be handled in this technique. Since the width of the program memory and the instruction word remain correlated, the target instruction of a jump operation can easily be fetched without any realignment, overhead or complication.

This technique can be implemented in several ways. Three examples of these possibilities are:
1. The program memory word is divided according to the different instruction word segments.
2. Each instruction word segment is stored on one line of the program memory.
3. The entire instruction word is stored on one program memory line, but only partially selected when fetched.

These three example implementations are described in greater detail as follows.

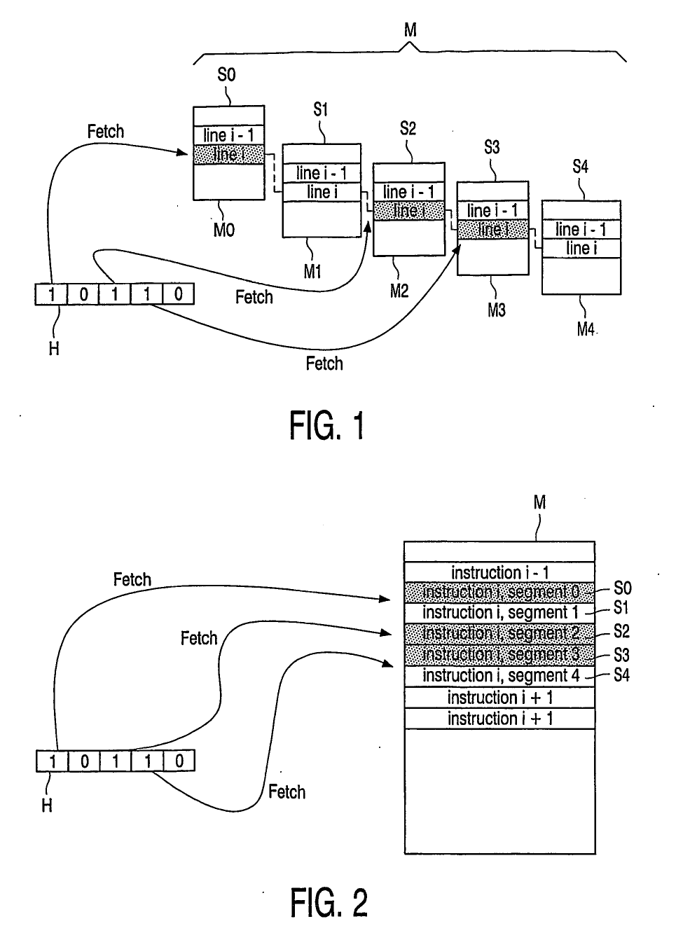

In FIG. 1 a first example of an implementation of the above described technique is shown, wherein the program memory width is divided according to the different instruction word segments S0, S1, S2, S3, S4. Thus, the program memory is replaced by several smaller memory portions M0, M1, M2, M3, M4 wherein each memory portion is associated with a respective segment of an instruction word. All these memory portions can be accessed in parallel. A previously fetched header H stipulates from which memory portions the instruction must be fetched. So, it is not loaded from a memory portion if so indicated by the header which applies to each NOP (no operation) segment in the stored instruction words. In the example shown, the second and the fifth bit in the header are 0, indicating that segment S1 and segment S4 comprise a NOP. The other segments comprise a valid instruction, indicated by binary value of “1” in the header. Of course also a reverse coding may be used. In this example there is no need to align the different segments; each segment can have an arbitrary width.

In FIG. 2 it is illustrated as a second example an implementation, wherein all segments S0, S1, S2, S3, S4 of the instruction words and the program memory M have the same width. Each instruction segment is stored on a separate line. Only the lines containing a relevant instruction segment are fetched from the program memory, whereas those lines are skipped which include instruction word segments which are not used for the current instruction and, thus, are NOP segments. So, a previously fetched header H indicates whether or not the loading of an instruction word segment such as segment S4 for instruction i be skipped.

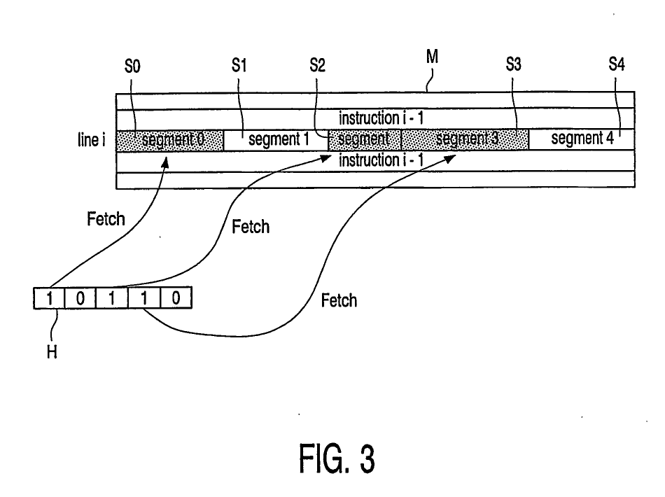

A third example of implementation is illustrated in FIG. 3, wherein the complete instruction word is stored on one program line of the memory M but is only read partially when the header indicates the presence of NOP instructions. This selective reading is feasible when it is supported by the program memory M. So, in this embodiment the program memory M is used in a manner that allows partial reading of an instruction word, i.e. only the segments indicated, here S0, S2, S3 by the previously fetched header H.

Although, the invention is described above with reference to the examples shown in the attached drawings, it is apparent that the invention is not restricted to it, but can vary in many ways within the scope disclosed in the attached claims.

1. A processor device for processing instructions, in particular very long instruction word (VLIW) instructions, comprising
memory means for storing instruction words, each instruction word consisting of segments,
fetching means for fetching instruction words from said memory means, and
executing means for executing instructions in accordance with instruction words fetched from said fetching means, characterized in that
said fetching means is adapted to fetch essentially those segments of an instruction word (line i) only which contain relevant information.

2. The device according to claim 1,
wherein said memory means is adapted to store instructions words of a kind where the instruction words have the same code size density.

3. The device according to claim 2,
wherein said memory means is adapted to store non-compressed instructions words.

4. The device according to claim 1,
wherein said memory means comprises a plurality of memory portions wherein each memory portion is provided to store one segment of an instruction word, and said fetching means is adapted to access those memory portions only which contain relevant information.

5. The device according to claim 1,
wherein said memory means includes a plurality of lines, each line being provided for storing a complete instruction word.

6. The device according to claim 4,
wherein the width of said memory means is divided over all lines into memory units in accordance with different segments of the instruction words so that each memory unit is formed by memory portions for storing instruction word segments of the same order and/or kind.

7. The device according to claim 4,
wherein all segments of the instruction words and said memory means have the same width, and each memory portion forms a separate line for storing an instruction segment.

8. The device according to claim 4,
wherein each line of said memory means is divided into said memory portions in accordance with different segments of the instruction words so that each memory portion is provided for storing one segment of an instruction word.

9. A method for processing instructions, in particular very long instruction word (VLIW) instructions, in a processor device, comprising the steps of
storing instruction words in a memory means, each instruction word consisting of segments,
fetching instruction words from said memory means, and
executing instructions in accordance with instruction words fetched from said fetching means,
characterized in that
essentially those segments of an instruction word are fetched only which contain relevant information.

10. The method according to claim 9,
wherein the instruction words have the same code size density.

11. The method according to claim 10,
wherein the instructions words are not compressed.

12. The method according to claim 9,
further comprising the step of dividing said memory means into a plurality of memory portions wherein each memory stores one segment of an instruction word.

13. The method according to claim 9,
further comprising the step of dividing said memory means into a plurality of lines, wherein each line stores a complete instruction word.

14. The method according to claim 12,
further comprising the steps of dividing the width of said memory means over all lines into memory units in accordance with different segments of the instruction words, and forming each memory unit by memory portions for storing instruction word segments of the same order and/or kind.

15. The method according to claim 12,
further comprising the steps of providing all segments of the instruction words and said memory means with the same width, and adapting each memory portion so as to form a separate line for storing an instruction segment.

16. The method according to claim 12,
further comprising the steps of dividing each line of said memory means into said memory portions in accordance with different segments of the instruction words, and adapting each memory portion so as to store one segment of an instruction word.
